(19) United States
(12) Patent Application Publication
(10) Pub. No.: US 2001/0027628 A1
(43) Pub. Date: Oct. 11, 2001

(54) Decorative member material

(76) Inventors: Kiyoshi Matsuki, Nishinomiya-shi (JP); Yoriki Kakimoto, Osaka (JP)

Correspondence Address: William R. McClellan, Wolf, Greenfield & Sacks, P.C., 600 Atlantic Avenue, Boston, MA, 02210, US

(21) Appl. No.: 09/756,399

(22) Filed: Jan. 8, 2001

(30) Foreign Application Priority Data
Mar. 29, 2000 (JP) 2000-090286

(51) Int. Cl. E06B 3/00; E04B 2/00; E04C 1/00; B44F 7/00

(52) U.S. Cl. 52/312; 52/208; 52/287.1; 52/288.1; 52/309.8

(57) ABSTRACT

A decorative member material, of which interior trim material is light weight, comfortable touch and can be used in spite of its low strength, is provided.

Decorative member material 1 which is equipped with exterior trim material 2 and interior trim material 3 which is fixed on inside face 2a of this exterior trim material 2, wherein interior trim material 3 is composed of cellular molded article in mold pattern 4, which is fixed on inside face 2a of exterior trim material 2, and surface skin material 5, which is melt united to one piece with at least inside face 4a of this cellular molded article in mold pattern 4, and at the same time, almost all of outside face 4b of cellular molded article in mold pattern 4 is contacted with inside face 2a of exterior trim material 2 or will be able to contact with it when an external force works.

### TECHNICAL FIELD

This invention relates to a decorative member material to be used for an automobile door or the like, which is equipped with an exterior trim member material such as door body of automobile and with an interior trim member material which is composed of a cellular molded article in mold pattern having surface skin, wherein this interior trim member material is fixed on the inside face of this exterior trim member material.

### BACKGROUND OF THE INVENTION

As a conventional decorative member material of this kind, for example, as illustrated in FIG. 4, automobile door 52 or the like is known, which is equipped with door body 2 and with door panel 51 being fixed on inside face 2a of this door body 2.

Generally, as door panel 51, it is employed that a surface skin material is adhered to inside face 53a of substrate 53 which is made from a panel shape or surface skin shape synthetic resin article (such as injection molded article) or made from a woody material. As the surface skin material, surface skin material 5 of a thermoplastic resin sheet or the like, or laminated with an extrusion-expanded sheet of thermoplastic resin 54 on back face 5b of this surface skin material 5, is employed. However, in such type of door panel 51, as employing synthetic resin or woody substrate 53, there is a problem of heavy weight.

Consequently, in order to lessen its weight, as illustrated in FIG. 5 for example, door panel 61 is proposed, which is composed of cellular molded article in mold pattern 4, which is formed by an expansion molding of expanded thermoplastic resin beads in mold pattern (expansion molding in mold pattern), and surface skin material 5, which is adhered on inside face 4a of this cellular molded article in mold pattern 4. Nevertheless, it is not successful yet in practical use.

The reason of that is, door panel 61, which is composed of such cellular molded article in mold pattern having surface skin, is light weight, but, since it employs this thin cellular molded article in mold pattern 4 as it is, there is a problem of poor strength. On the other hand, in order to improve the strength, in a case of lowering the expansion rate, cellular molded article in mold pattern 4 will stiffen and become an uncomfortable touch. Furthermore, since the total strength is not enough increased by only lowering the expansion ratio of cellular molded article in mold pattern 4, in a case of increasing the thickness of cellular molded article in mold pattern 4, it is often inevitable to increase its weight like falling into a minus chain connection.

While, as a measure for improving the strength without lowering the expansion ratio of cellular molded article in mold pattern 4, as illustrated in FIG. 6, it is proposed that reinforcing synthetic resin substrate 53 is fixed on outside face 4b of cellular molded article in mold pattern 4, however, the weight as the interior trim material is not clearly different from the above mentioned door panel 51 which is composed of surface skin material 5, extrusion-expanded sheet of thermoplastic resin 54 and substrate 53, and at the same time, since the intermediate layer as the cellular layer is composed by cellular molded article in mold pattern 4, there is a problem of increasing the total thickness.

This invention has been done for solving the above mentioned problem, and its object is to provide a decorative member material of which interior trim material is light weight and gives a comfortable touch as well as can be used despite of its low strength.

### DISCLOSURE OF THE INVENTION

To achieve the above mentioned object, an essential feature residing in the invention which is claimed in claim 1 is that, in a decorative member material which is equipped with an exterior trim material and an interior trim material which is fixed on the inside face of this exterior trim material, the above mentioned interior trim material is composed of a cellular molded article in mold pattern, which is fixed on the inside face of the above mentioned exterior trim material, and a surface skin material, which is united to one piece with at least the inside face of this cellular molded article in mold pattern, and at the same time, almost all of the outside face of the above mentioned cellular molded article in mold pattern is contacted with the inside face of the above mentioned exterior trim material or will be able to contact with it when an external force works.

An essential feature residing in the invention which is claimed in claim 2 is that, into a concave part, which is mounted on the outside face of the above mentioned cellular molded article in mold pattern, the apparatus, which is stationed on the inside face of the above mentioned exterior trim material, is inserted.

An essential feature residing in the invention which is claimed in claim 3 is that, the above mentioned interior trim material is an interior trim material for automobile, ship, train or aircraft.

An essential feature residing in the invention which is claimed in claim 4 is that, the above mentioned interior trim material for automobile is a door panel, an instrument panel or a pillar.

An essential feature residing in the invention which is claimed in claim 5 is that, the above mentioned cellular molded article in mold pattern is melt united to one piece with the above mentioned surface skin material.

An essential feature residing in the invention which is claimed in claim 6 is that, the above mentioned cellular molded article in mold pattern and the above mentioned surface skin material are composed of an olefin series resin.

An essential feature residing in the invention which is claimed in claim 7 is that, the above mentioned olefin series resin is a polypropylene series resin.

An essential feature residing in the invention which is claimed in claim 8 is that, a cellular sheet is laminated on the back face of the above mentioned surface skin material.

An essential feature residing in the invention which is claimed in claim 9 is that, the above mentioned cellular sheet is a cross-linked cellular article.

An essential feature residing in the invention which is claimed in claim 10 is that, the above mentioned cellular sheet is composed of an olefin series resin.

An essential feature residing in the invention which is claimed in claim 11 is that, the above mentioned olefin series resin is a polypropylene series resin.

### BRIEF DESCRIPTION OF THE DRAWINGS

For the better understanding of the invention as well as other objects and features thereof, reference is made to the following detailed description to be read in conjunction with the accompanying drawings, wherein:

FIG. 1 is a side view of an automobile.

FIG. 2 is an enlarged sectional explanation view illustrating an automobile door which is relating to embodiment 1.

FIG. 3 is an enlarged sectional explanation view illustrating an automobile door which is relating to embodiment 2.

FIG. 4 is an enlarged sectional explanation view illustrating a conventional example.

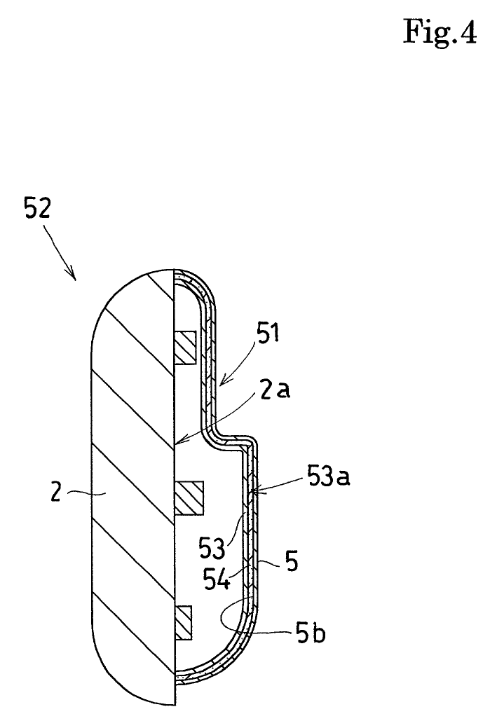

FIG. 5 is an enlarged sectional explanation view illustrating one other conventional example.

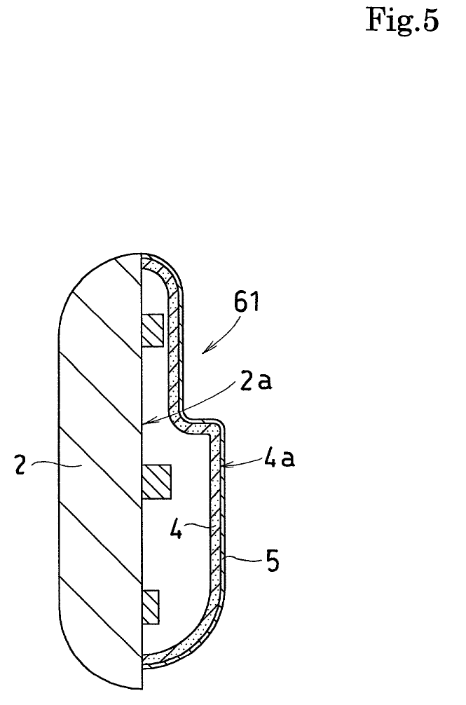

FIG. 6 is an enlarged sectional explanation view illustrating one more other conventional example.

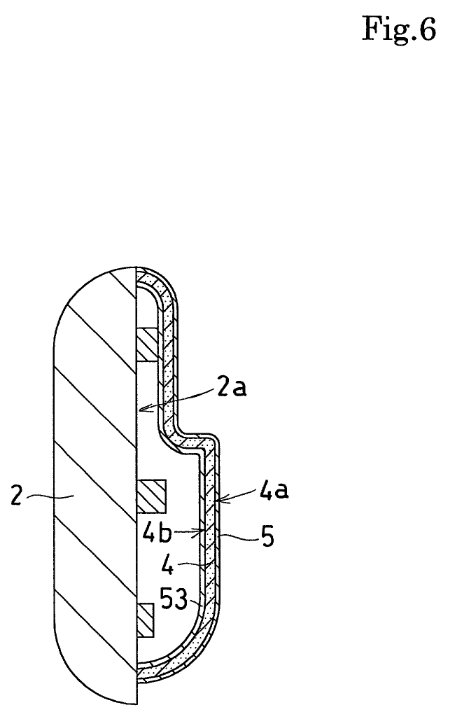

In the above mentioned drawings, marks represent as follows;

A: automobile (car)

1, 11: door (decorative member material)

2: door body (exterior trim material)

2a: inside face

3: door panel

4: cellular molded article in mold pattern

4a : inside face

4b : outside face

5: surface skin material

5b : back face

6: concave part

7, 8, 9: apparatus

12: cellular sheet

### BEST MODE FOR PRACTICING THE INVENTION

Embodiments of this invention are described below based on the attached drawings. In these drawings, the same mark is given to a same constitution as the above mentioned conventional technique.

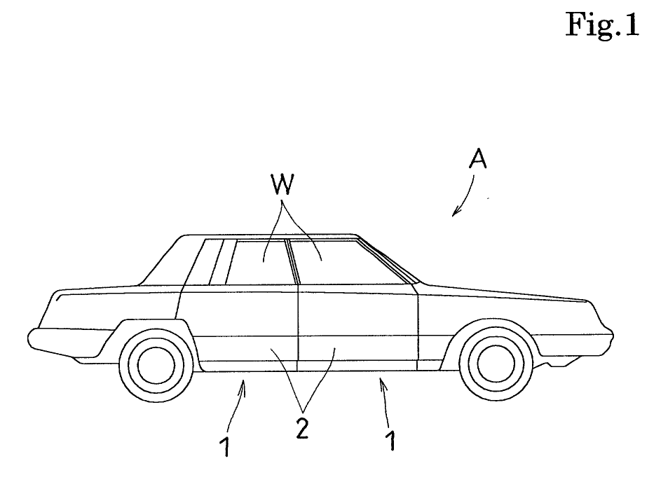

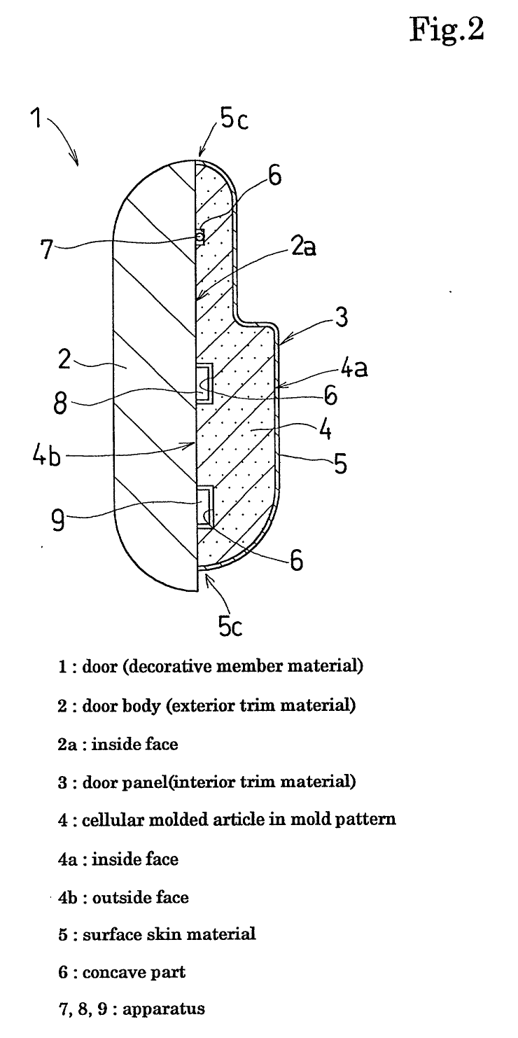

As illustrated in FIG. 1 and FIG. 2, door (decorative member material) 1 of an automobile (car), which is related to embodiment 1, is equipped with door body (exterior trim material) 2, which is fixed on the outside of side face of automobile A in a manner of rotating and opening or shutting freely, and with door panel (interior trim material) 3, which is fixed on inside face 2a of this door body 2.

Door panel 3 is constituted by cellular molded article in mold pattern 4, which is fixed on inside face 2a of door body 2, and surface skin material 5, which is united to one piece with inside face 4a of this cellular molded article in mold pattern 4. And, door window W is stored in the storage part (not shown) in a manner of putting in and out freely.

Cellular molded article in mold pattern 4 is fixed by an installation tool such as an insert material (not shown) so that almost all of outside face 4b will contact with inside face 2a of door body 2. A plural number of concave part 6 are mounted on outside face 4b of this cellular molded article in mold pattern 4, and, apparatus 7, 8 and 9, which are stationed on inside face 2a of door body 2, are inserted into these concave part 6.

Apparatus 7, 8 and 9 mean a general term of such as tool, instrument or machine, and it includes, for example, a motor for window, electric wiring, reinforcing material for door body 2 and fixing tools for these.

The depth of concave part 6 is preferably set that, in a state of door panel 3 being fixed on door body 2, it contacts with apparatus 7,8 and 9, or the gap in horizontal direction between these concave part 6 and apparatus 7, 8 and 9 is set at not more than 4 mm, preferably not more than 2 mm so that it will contact each other when an external force works. Furthermore, the other portion than concave part 6 on outside face 4b of cellular molded article in mold pattern 4 may also be opened some gap so as to contact each other when an external force works.

Cellular molded article in mold pattern 4 is an expansion molded article (expansion in mold) of the expanded beads of thermoplastic resin to a prescribed expansion ratio in a mold pattern. Surface skin material 5 is composed of such as a thermoplastic resin sheet of prescribed thickness.

And, surface skin material 5 may be not only on inside face 4a of cellular molded article in mold pattern 4 but also, by folding back of edge part 5c to outside face 4b or by such others, united to one piece with outside face 4b. On the other hand, cellular molded article in mold pattern 4 and surface skin material 5 may be adhered by an adhesive, however, in a case of melt uniting to one piece, since the interior trim material such as door panel 3, which is composed of a cellular molded article in mold pattern having surface skin, can be produced easily by a simultaneous unification molding, there is a merit that production cost down can be made.

In addition, in a case that cellular molded article in mold pattern 4 and surface skin material 5 are composed of an olefin series resin, as it is so called all olefin, there is a merit that recycling of the interior trim material is easy. While, in a case that the olefin series resin is a polypropylene series resin, there is a merit that durability or the like of the interior trim material is excellent. As this polypropylene series resin, for example, propylene homopolymer, ethylene-propylene random copolymer, ethylene-propylene block copolymer, ethylene-propylene-butene terpolymer, propylene-vinyl chloride copolymer, propylene-butene copolymer, propylene-maleic anhydride copolymer can be mentioned among others, and these can be used alone or as a mixture of not less than two of them. The polypropylene series resin is preferably not cross linked however, it may also be cross-linked by using a peroxide, radiation or the like. Furthermore, a mixture of the polypropylene series resin and other thermoplastic resin can also be used. As this kind of thermoplastic resin, for example, low density polyethylene, linear low density polyethylene, aromatic vinyl polymer, polybutene and ionomer can be mentioned among others. And as an amount of the thermoplastic resin to be mixed with, not more than 20 parts by weight of it against 100 parts by weight of the polypropylene series resin, preferably 5 to 10 parts by weight, is desirable.

As is described in the above, by means that almost all of outside face 4b of cellular molded article in mold pattern 4 is contacted with inside face 2a of the exterior trim material such as door body 2 or is able to contact with it when an external force works, as cellular molded article in mold pattern 4 will not deform excessively, even in a case that the strength of cellular molded article in mold pattern 4 is low, it will not happen to cause any damage. By this reason, a comfortable touch by raising the expansion ratio of cellular molded article in mold pattern 4 can be given, and at the same time, there is a merit of making it lighter. And also, the expansion ratio of cellular molded article in mold pattern 4 can be raised more than about 15 to 30 times.

While, by inserting apparatus 7, 8 and 9 into concave part 6, the decorative member material such as door 1 can profitably be produced without redesigning of the exterior trim material such as door body 2. Furthermore, in a case that the interior trim material is an interior trim material for automobile, there is a merit to provide an automobile having an interior trim material of light weight and comfortable touch. As the automobile, other than automobile A as in this embodiment, for example, bus, auto-track and trailer can be mentioned among others. In a case that the interior trim material for automobile is door panel 3, an instrument panel or a pillar like in this embodiment, as it is used largely in an automobile, there is a merit of making it lighter weight more effectively.

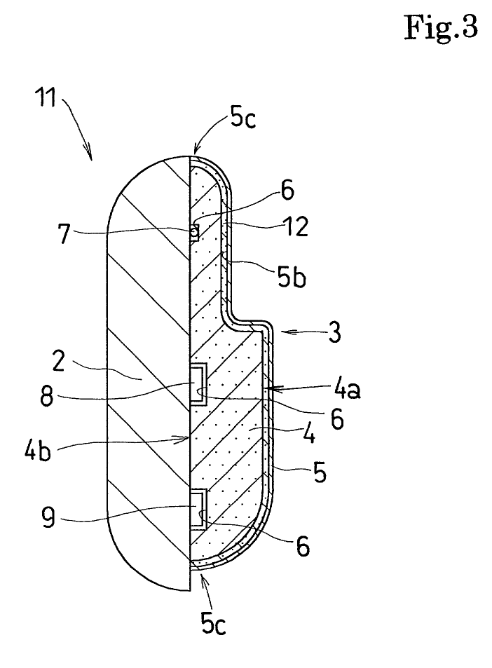

As is illustrated in FIG. 3, door 11 of automobile A which is related to embodiment 2 is that, in embodiment 1, cellular sheet 12 is laminated on back face 5b of surface skin material 5. By this method, there is a merit that touch feeling on the interior trim material such as door panel 3 is more comfortable than the case of surface skin material 5 alone. Furthermore, in a case that cellular sheet 12 is a cross-linked cellular article, there is a merit that a high durability or the like can be given. And, in a case that cellular molded article in mold pattern 4 and surface skin material 5 are composed of an olefin series resin, for making an easy recycling, it is desirable that this cellular sheet 12 is also composed of an olefin series resin such as a polypropylene series resin.

In the above embodiment 1 and embodiment 2, the decorative member material is used for door 1 or door 11 of automobile A, however, it is not only limited to these embodiments but also, in a case that the exterior trim material is a body or the like of ship, train or aircraft, it can be used as the interior trim material which is fixed on the inside face of this body or the like. Also in this case, as same as in the above mentioned, there is a merit that a ship having an interior trim material of light weight and comfortable touch or such others can be provided.

### EFFECTIVENESS OF THE INVENTION AS WELL AS POSSIBILITY FOR INDUSTRIAL USE

As in the above, according to the invention claimed in claim 1, as almost all of the outside face of the cellular molded article in mold pattern is contacted with the inside face of the exterior trim material or will be able to contact with it when an external force works, the cellular molded article in mold pattern will not be deformed excessively and also, even in a case that strength of the cellular molded article is not high enough, it will not be damaged. By this reason, there is a merit that a comfortable touch can be achieved by raising the expansion ratio of the cellular molded article in mold pattern, and at the same time, a further light weight can be made.

According to the invention claimed in claim 2, as the apparatus, which is stationed on the inside face of the exterior trim material, is inserted in the concave part, which is mounted on the outside face of the cellular molded article in mold pattern, there is a merit that the decorative member material such as door can be produced without redesigning the exterior trim material.

According to the invention claimed in claim 3, as the interior trim material is for interior trim material of automobile, ship, train or aircraft, there is a merit that an automobile having an interior trim material of light weight and comfortable touch can be provided.

According to the invention claimed in claim 4, as the interior trim material of automobile is a door panel, instrument panel or pillar, and therefore it is used largely in an automobile, there is a merit of making it lighter weight more effectively.

According to the invention claimed in claim 5, as the cellular molded article in mold pattern is melt united to one piece with the surface skin material, there is a merit that the interior trim material, which is composed of the cellular molded article in mold pattern having surface skin, can be produced easily by a simultaneous unification molding, and therefore, production cost down can be made.

According to the invention claimed in claim 6 and claim 10, as it is so called all olefin, in which the cellular molded article in mold pattern, the surface skin material, and also the cellular sheet are composed of an olefin series resin, there is a merit that recycling of the interior trim material is easy.

According to the invention claimed in claim 7 and claim 11, as the olefin series resin is a polypropylene series resin, there is a merit that durability or such other property of the interior trim material is excellent.

According to the invention claimed in claim 8, as the cellular sheet is laminated on the back face of the surface skin material, touch feeling on the interior trim material is more comfortable than in a case of the surface skin material alone.

According to the invention claimed in claim 9, as the cellular sheet is a cross-linked cellular article, there is a merit of high durability or such others.

Although the invention has been described in its preferred form with certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A decorative member material which is characterized in that, in a decorative member material which is equipped with an exterior trim material and an interior trim material which is fixed on the inside face of this exterior trim material, the above mentioned interior trim material is composed of a cellular molded article in mold pattern, which is fixed on the inside face of the above mentioned exterior trim material, and a surface skin material, which is united to one piece with at least the inside face of this cellular molded article in mold pattern, and at the same time, almost all of the outside face of the above mentioned cellular molded article in mold pattern is contacted with the inside face of the above mentioned exterior trim material or will be able to contact with it when an external force works.

2. A decorative member material as claimed in claim 1, wherein into a concave part, which is mounted on the outside face of the above mentioned cellular molded article in mold pattern, the apparatus, which is stationed on the inside face of the above mentioned exterior trim material, is inserted.

3. A decorative member material as claimed in claim 1, wherein the above mentioned interior trim material is an interior trim material for automobile, ship, train or aircraft.

4. A decorative member material as claimed in claim 3, wherein the above mentioned interior trim material for automobile is a door panel, an instrument panel or a pillar.

5. A decorative member material as claimed in claim 1, wherein the above mentioned cellular molded article in mold pattern is melt united to one piece with the above mentioned surface skin material.

6. A decorative member material as claimed in claim 1, wherein the above mentioned cellular molded article in mold pattern and the above mentioned surface skin material are composed of an olefin series resin.

7. A decorative member material as claimed in claim 6, wherein the above mentioned olefin series resin is a polypropylene series resin.

8. A decorative member material as claimed in claim 1, wherein a cellular sheet is laminated on the back face of the above mentioned surface skin material.
